(19) United States
(12) Patent Application Publication
(10) Pub. No.: US 2023/0005221 A1
(43) Pub. Date: Jan. 5, 2023

(54) GENERATING 3D PRINTING POINTS

(71) Applicants: Hewlett-Packard Development Company, L.P., Spring, TX (US); Universidade Federal de Pernambuco, Recife (BR)

(72) Inventors: Silvio B Melo, Pernambuco (BR); Luiz G.R. Charamba, Pernambuco (BR); Diogo B Henriques, Pernambuco (BR); Scott A White, Boise, ID (US)

(21) Appl. No.: 17/756,778

(22) PCT Filed: Jan. 6, 2020
(86) PCT No.: PCT/US2020/012422

§ 371 Date: Jun. 2, 2022

(51) Int. Cl. G06T 17/30; G06T 17/20; B29C 64/393; B33Y 50/02

(52) U.S. Cl. CPC G06T 17/30; G06T 17/20; B29C 64/393; B33Y 50/02

(57) ABSTRACT

A method for generating 3D printing points may include obtaining a Steiner patch that is part of a tessellation approximation of the 3D object, determining a parametric curve of a slicing plane and the Steiner patch, determining a classification of the parametric curve, sampling, based upon the classification, first and second points spaced by a parametric spacing along the parametric curve, determining a Euclidean spacing of the first and second points, and comparing the Euclidean spacing to a predefined spacing threshold. In response to the Euclidean spacing failing to satisfy the predefined threshold, sampling a third point along the parametric curve between the first and second points, generating 3D printing points in Euclidean space for the object based upon the first point, second point and third point sampled along the parametric curve.

### BACKGROUND

Three-dimensional (3D) printing is sometimes used to print a three-dimensional object on a layer-by-layer basis. Each layer corresponds to a slice of the three-dimensional object being printed. Each slice comprises printing points that are generated from a digital file of the three-dimensional object being printed. The generated printing points are used by a three-dimensional printer to print the three-dimensional object.

### BRIEF DESCRIPTION OF THE DRAWINGS

FIG. 1 is a block diagram schematically illustrating portions of an example 3D printing system.

FIG. 2 is a flow diagram of an example 3D printing point generation method.

FIG. 3A is a perspective view of an example sphere approximated by a mesh of Steiner patches.

FIG. 3B is a perspective view of an individual Steiner patch of the example sphere of FIG. 3A, together with its control points and edges.

FIG. 4A is a diagram of an example Steiner patch intersected by a slicing plane along a slicing curve in Euclidean space.

FIG. 4B is a diagram of an example parametric space including a parametric curve corresponding to the slicing curve of FIG. 4A.

FIG. 5 is a diagram illustrating examples of conic classifications.

FIG. 6 is a flow diagram of an example 3D printing point generation method.

FIG. 7A is a diagram of an example parametric space including a parametric curve along which parametric points are being sampled.

FIG. 7B is a diagram of an example Steiner patch being intersected by a slicing plane along a slicing curve, slicing curve corresponding to the parametric curve of FIG. 7A, wherein the slicing curve includes Euclidean points corresponding to the parametric points of FIG. 7A.

FIG. 8A is a diagram of an example parametric space including a parametric curve along which parametric points are being sampled.

FIG. 8B is a diagram of an example Steiner patch being intersected by a slicing plane along a slicing curve, slicing curve corresponding to the parametric curve of FIG. 8A, wherein the slicing curve includes Euclidean points corresponding to the parametric points of FIG. 8A.

FIG. 9A is a diagram of an example parametric space including a parametric curve along which parametric points are being sampled.

FIG. 9B is a diagram of an example Steiner patch being intersected by a slicing plane along a slicing curve, slicing curve corresponding to the parametric curve of FIG. 9A, wherein the slicing curve includes Euclidean points corresponding to the parametric points of FIG. 9A.

FIG. 10A is a diagram of an example parametric space including a parametric curve along which parametric points are being sampled.

FIG. 10B is a diagram of an example Steiner patch being intersected by a slicing plane along a slicing curve, slicing curve corresponding to the parametric curve of FIG. 10A, wherein the slicing curve includes Euclidean points corresponding to the parametric points of FIG. 10A.

FIG. 11 is a flow diagram of an example 3D printing point generation method.

FIG. 12 is a diagram illustrating reclassification of a parametric curve having an example non-degenerate conic classification to a degenerate conic classification.

FIG. 13A is a diagram illustrating an example Euclidean space having an example Steiner patch intersected by a slicing plane along a slicing curve.

FIG. 13B is a diagram of an example parametric space including an example parametric curve corresponding to the slicing curve of FIG. 13A.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Generating the printing points that form the slice of the three-dimensional object and that are used by the three-dimensional printer to print the three-dimensional object uses large amounts of memory, is often computationally burdensome and may be prone to inaccuracies. Generating such printing points necessitates use of a computational device or computer as such computations may be mathematically intense and may involve thousands to millions of different printing points for each slice of the three-dimensional object being printed.

An object may be modeled in a computer-assisted design (CAD) application. The CAD application may create a non-uniform rational basis spline (NURBS) representation of the object. A NURBS representation format may offer flexibility and precision in modeling the object. The NURBS representation may capture the surface area of the object being represented. A mesh format may be used to represent the same object. The mesh format may comprise multiple polygons connected along their sides. For example, different sizes and shapes of triangles may be used to represent the surface area of the object. The NURBS representation may be able to better capture curves of the object, while the mesh may approximate curves by using small polygons. The mesh may be more easily manipulated for other purposes, such as determining an intersection with a plane.

3D objects to be printed are sometimes defined by a tessellation or mesh of Steiner patches. The mesh of Steiner patches is sometimes referred to as a non-uniform rational quadratic splines (NURQS) model. A Steiner Patch, also known as a rational quadratic Bézier triangle, may be used to model the object to allow for more closely matching curves than planar triangles, while maintaining the operation of intersection with a plane as compared to a NURBS representation. A planar triangle may be represented by three points in Euclidean space, one per corner of the planar triangle. A point may include three numbers for coordinates, an x, y, and z. These coordinates may be represented by floating point numbers, or nine floating point numbers per planar triangle. A Steiner Patch may be represented by 21 floating point numbers, such as three corner points Euclidean space, three intermediary control points in Euclidean space, and one weight per intermediary control point. As the Steiner Patch allows modeling of a 3D curved triangle, modeling an object using a mesh of Steiner Patches may use less storage than modeling an object using a mesh of planar triangles, while doing so with a higher accuracy. Other curved triangles may also be used, such as a rational cubic Bézier triangle, or other higher degrees of curved triangles. Although Steiner patches may offer enhanced accuracy (smoother edges) as compared to polygon meshes and may simplify the representation of the 3D object (simpler intersection calculation and less computational burden) as compared to NURBS, generation of 3D printing points from Steiner patches or NURQS models may still be computationally intensive and burdensome.

Disclosed are example 3D printing points determination instructions, systems and computer implemented methods that may generate printing points of 3D slices of an object, using Steiner patches, with less computational resources and with enhanced 3D print accuracy. The example instructions, systems and computer implemented methods reduce the computational burden while enhancing accuracy: (1) by limiting the sampling of points along an parametric curve of the intersecting plane and a Steiner patch in parametric space to points between border points of the parametric curve; (2) by iteratively adding parametric sampling points along the parametric curve in parametric space until the spacing between each pair of consecutive corresponding Euclidean points in Euclidean space satisfies a predefined threshold; and/or (3) reclassifying a non-degenerate conic parametric curve as a degenerate conic parametric curve for sampling the parametric points along the parametric curve.

Disclosed is an example non-transitory computer-readable medium providing instructions for a processor. The instructions direct the processor to obtain a Steiner patch that is part of a tessellation approximation of a three-dimensional object to be printed by a 3D printer, determine a slicing curve, the slicing curve being an intersection of a slicing plane and the Steiner patch in Euclidian space, determine a parametric curve of the slicing curve, determine a classification of the parametric curve, determine border points of the parametric curve, sample points along the parametric curve between the border points of the parametric curve based on the classification, generate 3D printing points in Euclidean space for the object based upon the sampled points.

Disclosed is an example method for generating 3D printing points from Steiner patches. The example method may include obtaining a Steiner patch that is part of a tessellation approximation of the 3D object, determining a parametric curve of a slicing plane and the Steiner patch, determining a classification of the parametric curve, sampling, based upon the classification, first and second points spaced by a parametric spacing along the parametric curve, determining a Euclidean spacing of the first and second points, and comparing the Euclidean spacing to a predefined spacing threshold. In response to the Euclidean spacing failing to satisfy the predefined threshold, sampling a third point along the parametric curve between the first and second points, generating 3D printing points in Euclidean space for the object based upon the first point, second point and third point sampled along the parametric curve.

Disclosed is an example method for generating three-dimensional (3D) printing points for printing a 3D object. The method may include obtaining a Steiner patch that is part of a tessellation approximation of a three-dimensional object to be printed by a 3D printer, determining a slicing curve, the slicing curve being an intersection of a slicing plane and the Steiner patch in Euclidian space, determining a parametric curve of the slicing curve, the parametric curve having a non-degenerate conic classification, reclassifying the parametric curve as a degenerate conic classification, sampling points along the parametric curve based upon the degenerate conic classification and generating 3D printing points in Euclidean space for the 3D object based upon the points sampled along the parametric curve.

FIG. 1 is a block diagram schematically illustrating portions of an example 3D printing system 20. 3D printing system 20 carries out printing of a three-dimensional structure or object based upon data contained in a received object data file 22. The data contained in the object data file 22 defines a model of the three-dimensional object to be printed. System 20 comprises 3D printing points 3D printing point generator 26 and 3D printer 30.

3D printing point generator 26 generates the individual 3D printing slice/layer points 31 and transmits points 31 to 3D printer 30. 3D printer utilizes points 31 to form the layers of the 3D object defined by the object data file 22. In one implementation, 3D printer 30 selectively solidifies portions of 3D build material, in the form of powder or particulates, at each of the 3D printing points. In another implementation, 3D printer 30 selectively deposits or jets build material at each of the 3D printing points to form the layer of the object being printed. In some implementations, the 3D printing points may further serve to define where release materials or sacrificial materials are to be selectively deposited or formed by 3D printer 30. In one implementation, 3D printing points 3D printing point generator 26 is provided in a separate computing unit or device as 3D printer 30. In another implementation, 3D printing points 3D printing point generator 26 is incorporated into a single unit along with 3D printer 30.

3D printing point generator 26 comprises processor 32 and memory 34. Processor 32 comprises electronics or circuitry that carries out instructions provided by memory 34. Memory 34 comprises a non-transitory computer-readable medium that contains such instructions. As will be described hereafter, such instructions may direct processor 32 to generate 3D printing slice/layer points from Steiner patches or a NURQS model in a more efficient manner. Various implementations of the instructions contained in memory 34 may direct the process 32 to reduce the computational burden while enhancing accuracy: (1) by limiting the sampling of points along an parametric curve to points between border points of the parametric curve; (2) by iteratively adding sampling points along the parametric curve in parametric space until the spacing between each pair of consecutive sample points in Euclidean space satisfies a predefined threshold; and/or (3) reclassifying a non-degenerate conic parametric curve as a degenerate conic parametric curve for sampling the points along the parametric curve.

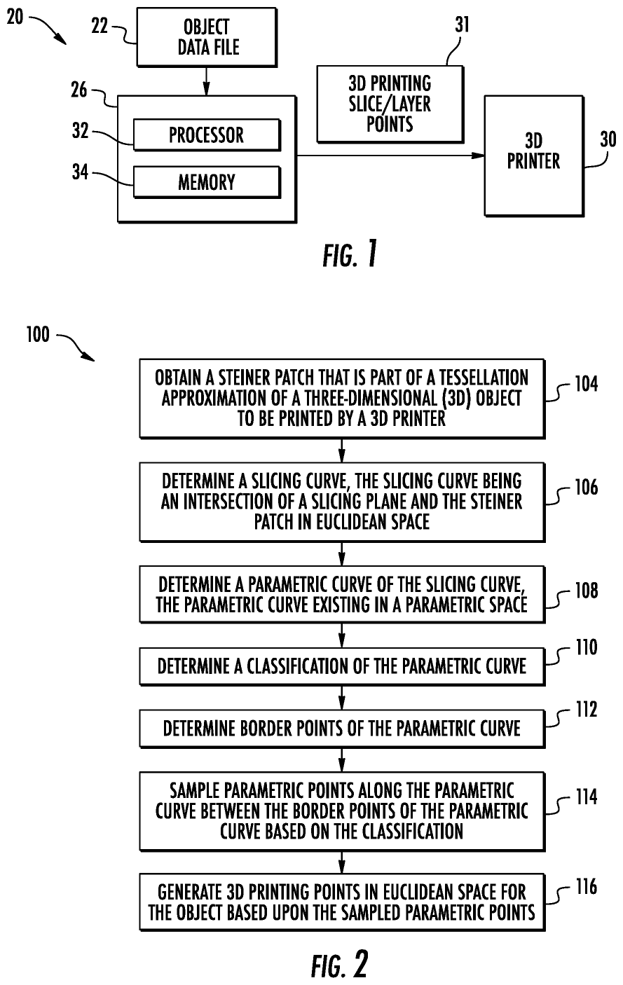

FIG. 2 is a flow diagram of an example method 100 that may be carried out by 3D printing point generator 26, wherein memory 34 contains instructions for directing processor 32 to carry out method 100. Method 100 may reduce the computational burden of generating 3D printing points using Steiner patches by limiting the sampling of points along a parametric curve to points between border points of the parametric curve.

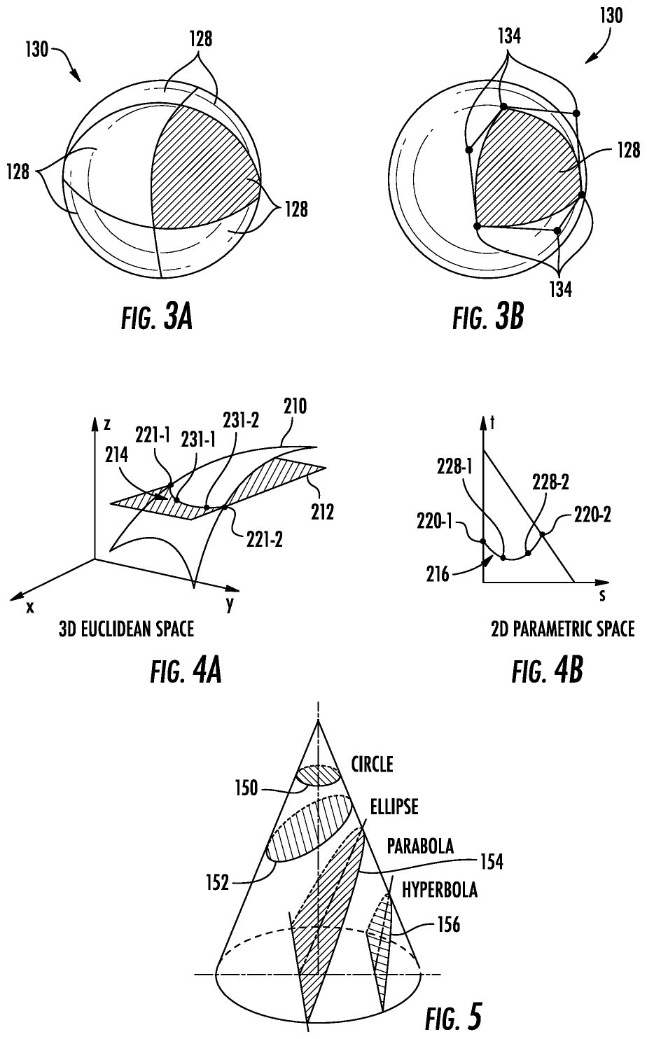

As indicated by block 104, 3D printing point generator 26 obtains an individual Steiner patch of a mesh of Steiner patches, the Steiner patch being part of a tessellation approximation of a three-dimensional object to be printed by 3D printer 30. FIG. 3A illustrates an example of a mesh of Steiner patches, or? a NURQS model, representing a three-dimensional object that may be printed. In the example illustrated in FIG. 3A, the mesh of Steiner patches 128 approximates a sphere 130. As should be appreciated, any variety of three-dimensional objects may be represented by a greater or fewer number of such Steiner patches. FIG. 3B illustrates an individual Steiner patch 128 of the sphere 130 of FIG. 3A and control points 134 which are the base ingredients of a mathematical expression to produce, along with a parametric information, points of the Steiner patch 128. The NURQS model may be provided as part of the object data file 22 supplied to 3D printing point generator 26 or may itself be generated from a model in another format contained in object data file 22. For example, in one implementation, the object data file 22 may contain a NURBS model from a computer aided design device, wherein 3D printing point generator 26 generates NURQS model of Steiner patches from the NURBS model in accordance with any of various existing and future developed techniques.

Upon obtaining the larger NURQS file, 3D printing point generator 26 proceeds by generating 3D printing points 31 for each individual Steiner patch of the NURQS model, the 3D printing points being sent to 3D printer 30 for printing the individual layer of the 3D object being printed. FIG. 4A illustrates an example individual Steiner patch 210 in Euclidean space. As indicated by block 106, 3D printing point generator 26 determines a slicing curve, the slicing curve being an intersection of a slicing plane and the Steiner patch in Euclidean space. The slicing plane corresponds to at least a portion of the layer of the 3D object to be printed and for which the 3D printing points are being generated. During the course of generating 3D printing points for printing the entire 3D object, each individual Steiner patch may be intersected by multiple different slicing planes, each of the slicing planes corresponding to the different layers of the object being printed on a layer-by-layer basis by printer 30. FIG. 4A illustrates an example slicing plane 212 and its associated slicing curve 214.

As indicated by block 108, 3D printing point generator 26 determines a parametric curve of the slicing plane. The parametric curve is a conic in parametric space and constitutes a pre-image of the slicing curve which is in Euclidean space. FIG. 4B further illustrates an example parametric curve 216 corresponding to the slicing curve 214.

As indicated by block 110, 3D printing point generator 26 determines a classification of the parametric curve, such as parametric curve 216. FIG. 5 illustrates various non-degenerate classifications of a parametric curve. As shown by FIG. 5, the parametric curve comprises a cross-section of a cone, comprising a conic. Example non-degenerate classifications for a parametric curve include a circle 150, an ellipse 152, a parabola 154 and a hyperbola 156. It should be noted that the illustrated example hyperbola appears on the upper half of a double cone and is not seen in FIG. 5. In some circumstances, the parametric curve may have a degenerate classification such as parallel lines, concurrent lines, a single-line, coincident lines or a single point. As will be described hereafter, the classification of the parametric curve determines how points are sampled along the parametric curve.

As indicated by block 112, using the classification of the parametric curve, 3D printing point generator 26 determines the border points of the parametric curve. FIG. 4B illustrates the example parametric curve 216 as having parametric border points 220-1 and 220-2 which correspond to border points 221-1 and 221-2 of slicing curve 214.

As indicated by block 114, based upon the classification of the parametric curve, 3D printing point generator 26 samples parametric points 228 along the parametric curve between the border points. By limiting the sampling of parametric points to those points on the parametric curve between the border points, computational resources are preserved.

As indicated by block 116, using points 228 sampled between the border points 220, 3D printing point generator 26 generates corresponding Euclidean points, the 3D printing points, in Euclidean space for the object to be printed. 3D printing point generator 26 converts the sample parametric points 228 in parametric space to corresponding points 231 along slice curve 214 in Euclidean space. Points 231 in Euclidean space serve as a 3D printing points 31 for the layer of build material that is to form portions of the Steiner patch approximating a portion of the object being printed. Upon being generated, the 3D printing points 31 may be output to the 3D printer 30 for printing a slice of the object.

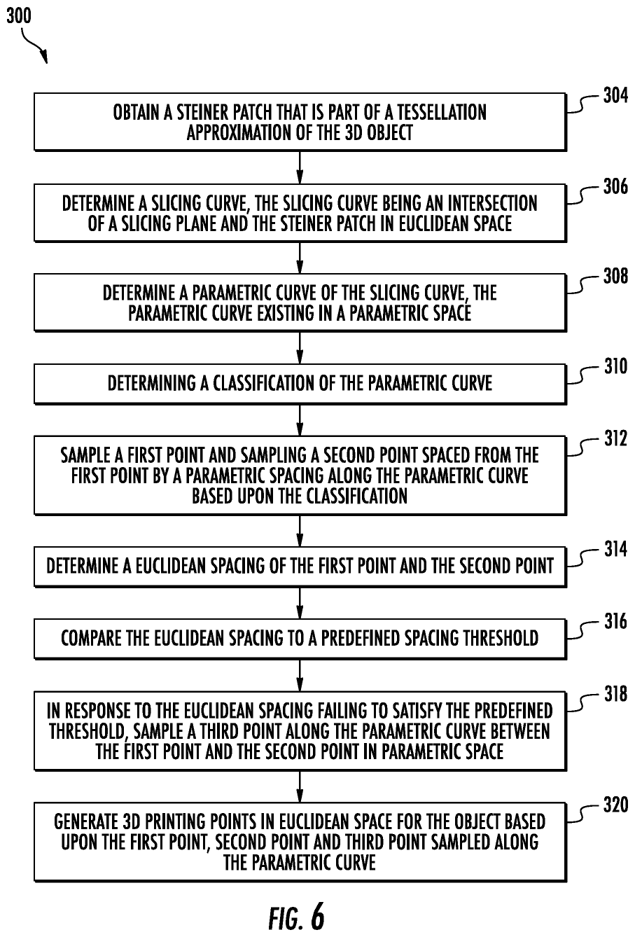

FIG. 6 is a flow diagram of an example method 300 that may be carried out by 3D printing point generator 26, wherein memory 34 contains instructions for carrying out method 300. Method 300 may reduce the computational burden and enhance printing resolution of generating 3D printing points using Steiner patches by iteratively adding sampling points along the parametric curve in parametric space until the spacing between each pair of consecutive sample points in Euclidean space (the Euclidean points corresponding to the parametric points in parametric space) satisfies a predefined threshold. Blocks 304-310 of method 300 correspond to blocks 104-110 of method 100, respectively, and are described above.

As indicated by block 312 and illustrated by FIG. 7A, upon determining the parametric curve and its classification, 3D printing point generator 26 begins sampling points along the parametric curve 216. In the example illustrated, 3D printing point generator 26 samples a first parametric point 228-1 and a second parametric point 228-2 along the parametric curve 216 between border points 220. Such sampling of points 228 is based upon the classification of the parametric curve 216. In one implementation, the sampling of parametric points 228-1 and 228-2 between border points 228 is random. In another implementation, the sampling points is done to equidistantly space points 228-1 and 228-2 from one another and from border points 220. In other implementations, the sampling of parametric points along parametric curve 216 in between border points 220 may be done in other fashions.

The sampled parametric points 228-1 and 228-2 have corresponding Euclidean points 231-1 and 231-2, respectively, on the slicing curve 214 in Euclidean space. However, the relative positions of the Euclidean points 231-1 and 231-2 are not necessarily the same as the relative positions of the parametric points 228-1 and 228-2 in parametric space. As indicated by block 314, 3D printing point generator 26 determines a Euclidean spacing 241 separating the Euclidean points 231-1 and 231-2. 3D printing point generator 26 may also determine a Euclidean spacing 243, along the slicing curve 214, separating Euclidean point 231-1 from border point 221-1 and a Euclidean spacing 245, along slicing curve 214, separating Euclidean point 231-2 from border point 228-2.

As indicated by block 316, 3D printing point generator 26 compares each of the Euclidean spacings 241, 243 and 245 against a predefined spacing threshold. The spacing threshold may be based upon a target tolerance or degree of resolution that itself may be a function of the precision of the 3D printer 30.

As indicated by block 318, in response to the Euclidean spacing or distance separating Euclidean points 231-1 and 231-2 failing to satisfy the threshold, and as shown by FIG. 8A, 3D printing point generator 26 samples a third parametric point 228-3 along the parametric curve 216 between the prior parametric points 228-1 and 228-2. In one implementation, location at which the third parametric point between parametric points 228-1 and 228-2 is randomly chosen. In another implementation, the location at which the third parametric point 228-3 between parametric points 228-1 and 228-2 is chosen so as to lie equidistantly between parametric points 228-1 and 228-2.

As indicated by block 320, 3D printing point generator 26 generates the 3D printing points in Euclidean space for the object to be printed based upon the first sample point 228-1, the second sample point 228-2 in the third sample point 228-3 along the parametric curve 216. In particular, 3D printing point generator 26 determines the Euclidean points 231-1, 231-2 and 231-3 that correspond to the parametric points 228-1, 228-2 and 228-3, respectively. Each of the Euclidean points 231-1, 231-2 and 231-3 serves as a 3D printing point for the particular slicing plane 212 and the particular Steiner patch 210.

The general process of sampling parametric points along the parametric curve 214, identifying the Euclidean points corresponding to the sampled parametric points, measuring or determining a Euclidean spacing between the Euclidean points correspond to the sample parametric points and sampling in additional parametric point between the two prior sample parametric points may be repeated until the Euclidean spacing between each Euclidean point on the slicing curve 214 satisfies the predefined spacing threshold. For example, block 314-318 many carried out with respect to parametric border. 220-1 and parametric point 228-1. In particular, 3D printing point generator 26 may compare the Euclidean spacing 243 (shown in FIG. 7B) to the predefined threshold and insert an additional parametric point between the parametric border point 220-1 and in the parametric point 228-1 should the Euclidean spacing failed to satisfy the predefined spacing threshold. 3D printing point generator 26 may likewise compare the Euclidean spacing 245 (shown in FIG. 7B) against the predefined spacing threshold and insert an additional parametric point between the parametric border point 221-2 and the parametric point 228-2. For each of these inserted parametric points, a corresponding Euclidean point may be identified in Euclidean space and used to generate a corresponding 3D printing point.

The above described iterations may continue following each insertion or sampling of a new parametric point between two consecutive previously sampled parametric points until each Euclidean spacing (or a predetermine percentage of Euclidean spacings) between Euclidean points corresponding to the parametric points satisfy the predefined spacing threshold. For example, as shown by FIG. 8B, following the insertion of the newly sampled parametric point 228-3 between parametric points 228-1 and 228-2, 3D printing point generator 26 determines the coordinates of the Euclidean point 231-3 on the slicing curve 214 that corresponds to the parametric point 228-3. 3D printing point generator 26 then determines the Euclidean spacings on either side of the newly inserted Euclidean point 231-3 separating the Euclidean point 231-3 from the next consecutive Euclidean point on slicing curve 214. In the example illustrated, 3D printing point generator 26 determines the Euclidean spacing 247 spacing Euclidean points 231-1 and 231-3 and Euclidean spacing 249 spacing Euclidean points 231-3 and 231-2. 3D printing point generator 26 then compares each of the determine Euclidean spacings 247 and 249 against the predefined spacing threshold.

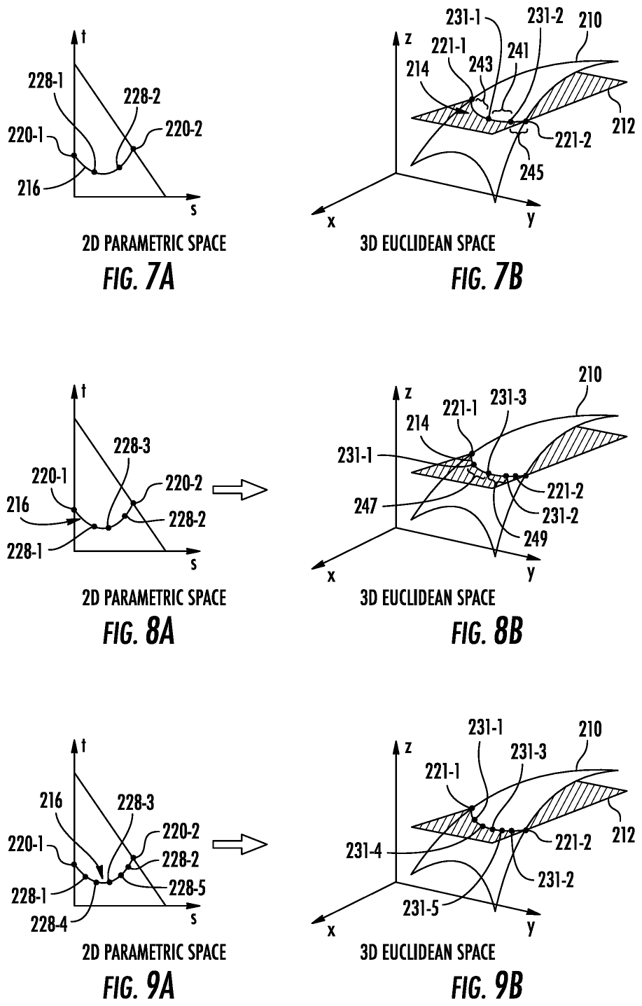

As shown by FIG. 9A, in response to the Euclidean spacing 247 being greater than the predefined spacing threshold, 3D printing point generator 26 proceeds by inserting or sampling yet another parametric point 228-4 between the parametric points 228-1 and 228-3 which correspond to Euclidean points 231-1 and 231-3. In response to the Euclidean spacing 249 being greater than the predefined spacing threshold, 3D printing point generator 26 proceeds by inserting or sampling yet another parametric point 228-5 between the parametric points 228-3 and 228-2 which correspond to Euclidean points 231-3 and 231-2. As shown by FIG. 9B, each of the parametric points 228-1, 228-2, 228-3, 228-4 and 228-5, as well as the border parametric points 220-1 and 220-2 has a corresponding Euclidean point along the slicing curve 214 which serves as a 3D printing point. As discussed above, this process iteratively continues until each determined Euclidean spacing between consecutive Euclidean points along the slicing curve 214 satisfy the predefined spacing threshold or until another Euclidean spacing criteria, such as a percentage of the locating spacings, is satisfied. Once all of the parametric points and their corresponding Euclidean points have been determined, and the 3D printing points corresponding to the Euclidean points have been generated, the 3D printing points may be used by 3D printer 30 to print a slice of the 3D object.

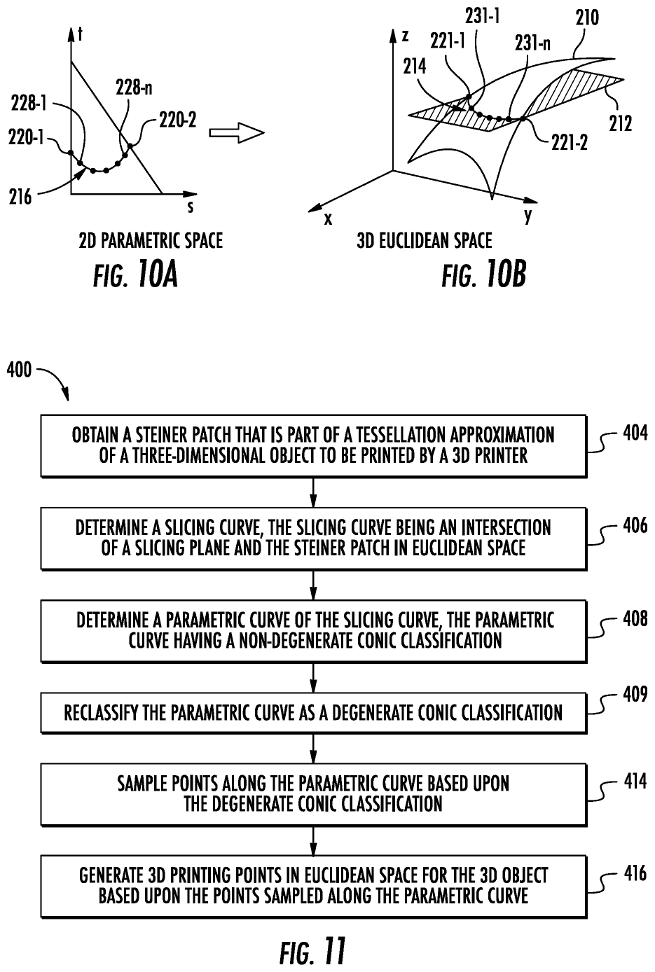

As shown by FIG. 10A, in some implementations, 3D printing point generator 26 may sample a predefined number of initial parametric points between the border parametric points 220 before determining any Euclidean spacings for the parametric points. For example, 3D printing point generator 26 may initially sample parametric points 228-1 to 228-n between border parametric points 220, wherein n may be a number greater than two. For example, 3D printing point generator 26 may initially sample 100 parametric points 231 on the parametric curve 216.

As shown by FIG. 10B, each of the parametric points 231 that are sampled have a corresponding Euclidean point on slicing curve 214. For each consecutive pair of Euclidean points on slicing curve 214, 3D printing point generator 26 may determine a Euclidean spacing between such Euclidean points. For every instance where the determined Euclidean spacing fails to satisfy the predetermined spacing threshold, 3D printing point generator 26 may proceed with sampling inserting a new parametric point between the parametric points that corresponded to the two Euclidean points separated by the Euclidean spacing that failed to satisfy the predetermined spacing threshold. As above, each insertion of a new parametric point results in the insertion of a new Euclidean point, wherein 3D printing point generator 26 determines new Euclidean spacings on each side of the new Euclidean point to determine whether the new Euclidean spacings satisfy the predetermined spacing threshold.

FIG. 11 is a flow diagram of an example method 400 that may be carried out by 3D printing point generator 26, wherein memory 34 contains instructions for directing processor 32 to carry out method 100. Method 400 may reduce the computational burden of generating 3D printing points using Steiner patches by reclassifying a non-degenerate conic parametric curve as a degenerate conic parametric curve for sampling the points along the parametric curve. Blocks 404 and 406 correspond to blocks 104 and 106 of method 100 and are described above.

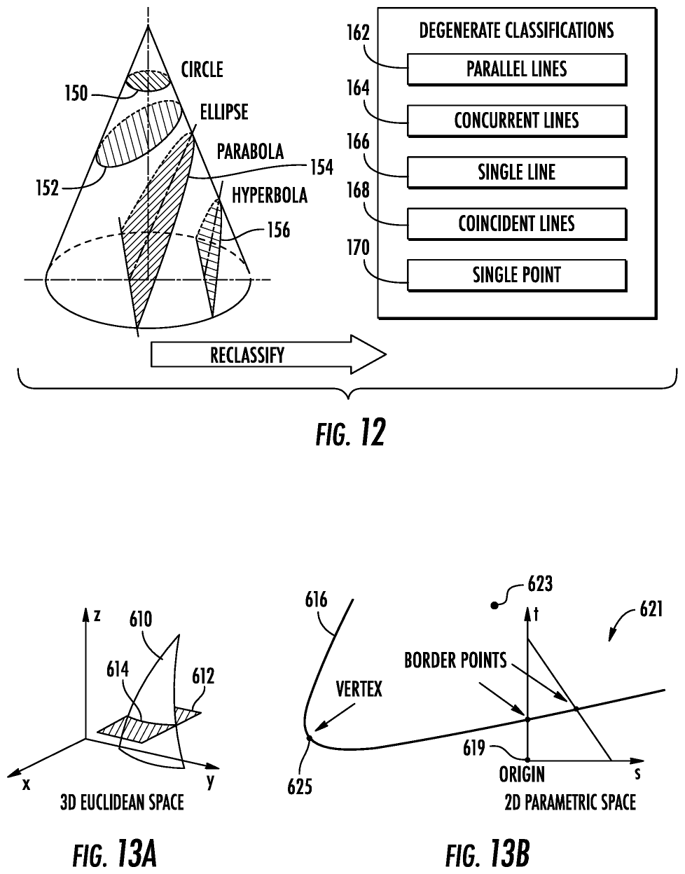

Block 408 is similar to block 108 described above except that the parametric curve determined by 3D printing point generator 26 in block 408 has a non-degenerate conic classification. In particular, the parametric curve has a conic classification selected from a group of classifications consisting of a circle 150, and ellipse 152, a parabola 154 and a hyperbola 156 as shown in FIG. 12.

As indicated by block 409, 3D printing point generator 26 automatically reclassify the parametric curve as a degenerate conic classification. Although the actual conic shape of the parametric curve is that of a non-degenerate conic, 3D printing point generator 26 treats the parametric curve as a degenerate conic fast occasion so as to reduce processing demands. As further shown by FIG. 12, 3D printing point generator 26 analyzes the shape, characteristics and distances between various points of the parametric curve and based upon such analysis reclassifies the parametric curve as a degenerate, sampling the parametric points along the parametric curve using mathematical formula and compilations as if the parametric curve actually comprised parallel lines 162, concurrent lines 164, a single line 166, coincident lines 168 or a single point 170.

FIGS. 13A and 13B illustrate one example of a circumstance where 3D printing point generator 26 carries out method 402 reclassify an otherwise non-degenerate parametric curve with a degenerate conic classification. FIG. 13A illustrates an example Steiner patch 610 intersected by an example slicing plane 612. As discussed above, Steiner patch 610 is part of a mesh or tessellation of Steiner patches (a NURQS model), wherein slicing plane 612 corresponds to portions of the individual layer of the 3D object being printed by 3D printer 30. FIG. 13A further illustrates the example slicing curve 614 formed by the intersection of Steiner patch 610 and slicing plane 612.

FIG. 13B illustrates the corresponding parametric curve 616 in parametric space. In the example illustrated, parametric curve 616 has a parabola conic classification. In response to determining that parametric curve 616 has a parabola conic classification, 3D printing point generator 26 evaluates selected points of permit curve 616 relative to portions of the parametric space to determine whether the particular parametric curve 616 should instead be reclassified or alternatively treated as a degenerate conic classification, such as a single line classification.

In one implementation, 3D printing point generator 26 determines a parametric distance of a point of the parametric curve 616 from an origin 619 of the parametric space 621. Generator 61 compares the determine parametric distance to a predefined distance threshold. In response to the distance threshold being satisfied, being greater than a predetermined threshold, 3D printing point generator 26 classifies curve 616 as a single line classification. The single line classification is used to sample points along the parametric curve 616, wherein classifying points along a single line parametric curve may be less computationally burdensome as compared to sampling parametric points along a parametric curve having a parabola conic classification.

In one implementation, the point evaluated by 3D printing point generator 26 to determine the parametric distance comprises a center 623 of the parametric curve 616. 3D printing point generator 626 determines the parametric distance by comparing the coordinates of the center 623 and the origin 619. In response to the parametric distance satisfying the predefined distance threshold, 3D printing point generator 26 classifies curve 616 as a single line classification.

In another implementation, the point evaluated by 3D printing point generator 26 to determine the parametric distance comprises a vertex 625 of the parabola forming parametric curve 616. Generator 626 uses the coordinates of the vertex 625 relative to the coordinates of origin 619 to determine the parametric distance in response to the parametric distance satisfying the predefined distance threshold, 3D printing point generator 26 classifies curve 616 as a single line classification.

As shown by FIG. 11, upon reclassifying the parametric curve, 3D printing point generator 26 proceeds with blocks 414 and 416. Blocks 414 in foreign 16 correspond to blocks 114 and one earned 16 of method 100 described above. As described above, 3D printing point generator 26 samples points along the parametric curve based upon the reclassification, the degenerate conic classification. In the example illustrated in FIGS. 13A and 13B, 3D printing point generator 26 samples parametric points along the parametric curve based upon the degenerate single line conic classification. As indicated by block 416, using the parametric points sampled in block 414, 3D printing point generator 26 generates Euclidean points, 3D printing points, in Euclidean space for the 3D object.

Each of the above described methods 100, 300 and 400 may be combined as part of a single overall 3D printing point generation method. For example, in one implementation, memory 34 of 3D printing point generator 26 may contain instructions for directing processor 32 to carry out a single overall method similar to method 300 described above except that the points are specifically sample between the parametric border points as described above with respect to method 100 and that block 310 comprises an evaluation of the parametric curve and possible reclassification of a parametric curve having a non-degenerate conic classification as a parametric curve having a degenerate conic classification, such as a single line classification as described above with respect to method 400.

Below is a description of the mathematical foundations and computations that may be carried out by 3D printing point generator 26 in accordance with instructions contained in memory 34 when generating 3D printing points in accordance with the above described methods. It should be appreciated that the above described methods may be carried out using other mathematical computations or other transformations of Steiner patches provided in or derived from the data contained in the object data file 22. As noted above, A Steiner Patch in rational form as a function of parameters (s, t), given the control points P₂₀, P₀₂, P₁₀, P₀₁, P₁₁ and P₀₀, along with their intermediary weights w₁₀, w₀₁ and w₁₁, described as follows:

$$S ( s , t ) = \frac{{A}_{20} {s}^{2} + {A}_{02} {t}^{2} + {A}_{11} st + {A}_{10} s + {A}_{01} t + {P}_{00}}{{D}_{20} {s}^{2} + {D}_{02} {t}^{2} + {D}_{11} st + {D}_{10} s + {D}_{01} t + 1} \qquad ( Eq . 1 )$$

where:

A₂₀=P₂₀+P₀₀−2w₁₀P₁₀ and D₂₀=2−2w₁₀

A₀₂=P₀₂+P₀₀−2w₀₁P₀₁ and D₀₂=2−2w₀₁

A₁₀=2w₁₀P₁₀−2P₀₀ and D₁₀=2w₁₀−2

A₀₁=2w₀₁P₀₁−2P₀₀ and D₀₁=2w₀₁−2

A₁₁=2P₀₀+2w₁₁P₁₁−2w₀₁P₀₁−2w₁₀P₁₀ and D₁₁=2+2w₁₁−2w₁₀−2w₀₁.

In order for the slicing process to occur, an intersection between such a patch and a plane parallel to the printing bay of the 3D printer is utilized. This process is described by the implicit equation: z=kₚ, where kₚ designates a height of a certain layer, measured from the printing bay up. The intersection can be calculated by just taking the z-component of Eq. 1 and equating to kₚ. If we let the z-component of Aᵢⱼ to be zᵢⱼ, then the intersection yields the following equation on s and t parameters:

(z₂₀−D₂₀kₚ)s²+(z₁₁−D₁₁kₚ)st+(z₀₂−D₀₂kₚ)t²+(z₁₀−D₁₀kₚ)s +(z₀₁−D₀₁kₚ)t+(z₀₀−kₚ)=0

This equation can be further simplified by renaming the s and t terms' multipliers with C₁, C₂, . . . , C₅ and naming the independent term (z₀₀−kₚ)=C₆, thus making

C₁s²+C₂st+C₃t²+C₄s+C₅t+C₆=0 (Eq. 2)

Equation 2 describes a conic curve in parametric space, which is the pre-image of the intersection between the Steiner Patch and the plane (in the Euclidean space). To properly sample points in this curve, a determination is made as to which type of conic this equation refers to, and that means that a new system of coordinates (with new variables s′ and t′) in the parametric space should be established in a such a way that the mixed term s′t′ does not show up in the new equation.

In Equation 2 the C₂st term being non zero is an indication that the new axes of the variables s′ and t′ are to be rotated of a certain angle αₛ in relation to their counterparts s and t in order for the mixed term s′t′ to become nullified in the yielded equation. The angle αₛ is already known in Analytical Geometry as being such that

$$tan ( 2 {α}_{s} ) = \frac{{C}_{2}}{{C}_{1} - {C}_{3}} ,$$

in case C₁−C₃≠0, otherwise αₛ=45°. This is analogous to rotating the parametric space of the Steiner patch such that it aligns with the canonical axis as shown in FIG. 3. The rotation of αₛ produces the relations: s=s′ cos(αₛ)−t′ sin(αₛ) and t=s′ sin(αₛ)+cos(αₛ) that can be plugged into Equation 2 to generate the following reduced equation of a conic in the variables s′ and t′:

K₁s′²+K₂t′²+K₃s′+K₄t′+C₆=0 (Eq. 3)

where

K₁=C₁ cos²αₛ+C₂ cos αₛ sin αₛ+C₃ sin²αₛ

K₂=C₁ cos²αₛ−C₂ cos αₛ sin αₛ+C₃ cos²αₛ

K₃=C₄ cos αₛ+C₅ sin αₛ

K₄=−C₄ sin αₛ+C₅ cos αₛ

With Equation 3 it is possible to classify the type of conic which is in the parametric space the pre-image of the slice curve that comes from the intersection between a Steiner patch and a plane. First, a check is made as to whether this is a degenerate conic (single point, intersecting lines, parallel lines and coincident lines). Consider the following symmetric matrix:

$$M = \frac{1}{2} ( \begin{matrix}2 {C}_{1} & {C}_{2} & {C}_{4} \\ {C}_{2} & 2 {C}_{3} & {C}_{5} \\ {C}_{4} & {C}_{5} & 2 {C}_{6}\end{matrix} )$$

If the determinant of M is zero, then the conic is degenerate. Otherwise, in the case of non-degeneracy, if on top of this K₁ and K₂ are both nonzero and present the same sign, then Equation 2 represents an Ellipse and If they present opposite signs, then Equation 2 represents a hyperbola. If either K₁ or K₂ are zero, then Equation 2 represents a parabola. Each type of conic uses its own form of parametrization, which has also to take into consideration the parametrization speed, in order to produce an equally spaced sampling, or at least as close as possible to this.

Unless explicitly defined otherwise, the calculation of the patch-plane intersection curve is a conic in parametric space which is further parameterized in terms of an angle θₛ covering the full length of the conic. Since, generally, a portion of the conic is contained within the parametric space of the patch, this angle θₛ will be bounded by the inferior and superior limits of the border points. The general algorithm for slice computation comprises finding the appropriate parameterization in terms of θₛ, finding the points where the slice intersects with the patch's border, finding the correspondent parameters of θₛ for the border points and sampling the slice for the valid interval of θₛ. The computed points are yielded in terms of the transformed parametric space (s′, t′). A final transformation to (s, t) is used and can be computed through

s=s′ cos(αₛ)−sin(αₛ),t=s′ sin(αₛ)+cos(αₛ).

General Notation

The detailed process of computing the slices is broken down for each classification of the conic that is the pre-image of the intersection between a Steiner patch and a plane. These are the non-degenerate cases of the ellipse, parabola, hyperbola and the degenerate cases of intersecting lines, parallel lines, single line and point. There is also a special case—treated separately—where the conic arc segment is so far from the center that it is approximately straight for the portion that intersects with the patch.

To simplify the calculations for obtaining the slices, it is useful to define some previous notations.

### Let

$${G}_{1} = \frac{1}{\vert {K}_{1} \vert} ( \frac{1}{4} \frac{{K}_{3}^{2}}{{K}_{1}} + \frac{1}{4} \frac{{K}_{4}^{2}}{{K}_{2}} - {K}_{5} ) , {G}_{2} = \frac{1}{\vert {K}_{2} \vert} ( \frac{1}{4} \frac{{K}_{{3}^{2}}}{{K}_{1}} + \frac{1}{4} \frac{{K}_{{4}^{2}}}{{K}_{2}} - {K}_{5} ) , {A}_{s} = \sqrt{\vert {G}_{1} \vert} , {A}_{t} = \sqrt{\vert {G}_{2} \vert} , {s}_{0}^{′} = \frac{- {K}_{3}}{2 {K}_{1}} and {t}_{0}^{′} = \frac{- {K}_{4}}{2 {K}_{2}} .$$

Ellipse Slicing

As will be recurrent, the slicing method will first determine the parameter value θₛ^{b} for the border point and then iterate θₛ over the valid range. The parameter value θₛ^{b} can be found by inputting the values of (s_{b}′,t_{b}′) (transformed from the point's corresponding (s, t) parameters) for a border point b in the following equations:

$${θ}_{s}^{b} = \{ \begin{matrix}arccos ( \frac{{s}_{b}^{′} - {s}_{0}^{′}}{{A}_{s}} ) , & if arcsin ( \frac{{t}_{b}^{′} - {t}_{0}^{′}}{{A}_{s}} ) < 0 \\ 2 π - arccos ( \frac{{s}_{b}^{′} - {s}_{0}^{′}}{{A}_{s}} ) , & otherwise\end{matrix} .$$

Once the bounds for θₛ are defined, the actual slice can be computed by evaluating the parameter within the specified range such that

s′=s′₀+Aₛ cos(θₛ),t′=t′₀+Aₜ sin(θₛ).

Hyperbola Slicing

Hyperbola slicing differs from the ellipse slicing due to the caveat that there are potentially two segments which are accounted for. For this type of conic, it is useful to separate the calculations of the border point parameter θₛ^{b} by the quadrant in which the arc segment is located. The conditions for the value of θₛ^{b} are given in the table below and will depend on the values of K_{cos} and Kₜₐₙ computed as:

$${K}_{cos} = \{ \begin{matrix}\frac{{A}_{s}}{{s}_{b}^{′} - {s}_{0}^{′}} , & if {G}_{2} < 0 \\ \frac{{A}_{s}}{{t}_{b}^{′} - {t}_{0}^{′}} , & if {G}_{1} < 0\end{matrix} , {K}_{tan} = \{ \begin{matrix}\frac{{t}_{b}^{′} - {t}_{0}^{′}}{{A}_{s}} , & if {G}_{2} < 0 \\ \frac{{s}_{b}^{′} - {s}_{0}^{′}}{{A}_{s}} , & if {G}_{1} < 0\end{matrix}$$

| Quadrant | arccos(K_{cos}) | arctan(Kₜₐₙ) | θₛ^{b} |
|---|---|---|---|
| First | < [symbol] | >0 | arccos(K_{cos}) |
| Second | ≥ [symbol] | >0 | arctan(Kₜₐₙ) + π |
| Third | ≥ [symbol] | ≤0 | arccos(K_{cos}) |
| Fourth | < [symbol] | ≤0 | arctan(Kₜₐₙ) + π |

[symbol]

indicates data missing or illegible when filed

Once the limits for θₛ have been established, the slicing can be evaluated from the (s′, t′) parameters computed as:

$${s}^{′} = \{ \begin{matrix}{s}_{0}^{′} + {A}_{s} {cos}^{- 1} ( {θ}_{s} ) , & if {G}_{2} < 0 \\ {s}_{0}^{′} + {A}_{s} tan ( {θ}_{s} ) , & otherwise\end{matrix} , {t}^{′} = \{ \begin{matrix}{t}_{0}^{′} + {A}_{t} tan ( {θ}_{s} ) , & if {G}_{2} < 0 \\ {t}_{0}^{′} + {A}_{t} {cos}^{- 1} ( {θ}_{s} ) , & otherwise\end{matrix}$$

Parabola Slicing

For the parabola-type slicing, a new definition for s′₀ and t′₀ is given. Besides, a new coefficient of dv is also defined. Have

$${s}_{0}^{′} = \frac{1}{{K}_{3}} ( {K}_{5} - \frac{{K}_{4}^{2}}{4 {K}_{2}} ) , {t}_{0}^{′} = \frac{- {K}_{4}}{2 {K}_{2}} and dv = \frac{- {K}_{3}}{4 {K}_{2}} if {K}_{1} = 0 or {s}_{0}^{′} = \frac{- {K}_{3}}{4 {K}_{2}} , {t}_{0}^{′} = \frac{1}{{K}_{4}} ( {K}_{5} - \frac{{K}_{3}^{2}}{4 {K}_{1}} ) and dv = \frac{- {K}_{4}}{2 {K}_{1}}$$

otherwise. Once again, the values for the parameters θₛ^{b} can be computed from the transformed (s′_{b},t′_{b}) parameters of the border points. Make

$${θ}_{s}^{b} = \{ \begin{matrix}\frac{{t}_{b}^{′} - {t}_{0}^{′}}{2 dv} , & if {K}_{1} = 0 \\ \frac{{s}_{b}^{′} - {s}_{0}^{′}}{2 dv} , & otherwise\end{matrix} .$$

Once θₛ^{b} has been defined, the values for (s′, t′) of the slicing, points can be obtained by varying θₛ within the valid interval such that:

$${s}^{′} = \{ \begin{matrix}{θ}_{s}^{2} dv + {s}_{0}^{′} , & if {K}_{1} = 0 \\ 2 {θ}_{s} dv + {s}_{0}^{′} , & otherwise\end{matrix} , {t}^{′} = \{ \begin{matrix}2 {θ}_{s} dv + {t}_{0}^{′} , & if {K}_{1} = 0 \\ {θ}_{s}^{2} dv + {t}_{0}^{′} , & otherwise\end{matrix} .$$

Degenerate Conic Curves

Let

$$ζ = det ( \begin{matrix}{C}_{1} & \frac{1}{2} {C}_{3} & \frac{1}{2} {C}_{4} \\ \frac{1}{2} {C}_{3} & {C}_{2} & \frac{1}{2} {C}_{5} \\ \frac{1}{2} {C}_{4} & \frac{1}{2} {C}_{5} & {C}_{6}\end{matrix} ) , λ = det ( \begin{matrix}{C}_{1} & \frac{1}{2} {C}_{3} \\ \frac{1}{2} {C}_{3} & {C}_{2}\end{matrix} ) , Ω = det ( \begin{matrix}{C}_{1} & \frac{1}{2} {C}_{4} \\ \frac{1}{2} {C}_{4} & {C}_{6}\end{matrix} ) .$$

A conic that is the pre-image of the intersection between a Steiner Patch and a plane is considered degenerate if ζ=0. A further classification is given by the values of λ and Ω. If λ>0 the conic is reduced to a point, and if λ<0 it is reduced to a pair of intersecting lines. In the case of λ=0, the conic will be classified as coincident lines if Ω=0, or parallel lines if Ω<0.

Intersecting Lines Slicing

The conic image will be classified as the degenerate type of intersecting lines if either C₁ or C₂ are zero. As this conic type is composed of two independent line segments which intersect at a point, it is natural to first identify the parameters for the limits of the valid region of the segments within the patch and then iterate over the segment. The value of the valid (s, t) parameters for the points will depend on whether C₁ or C₂ is zero. Since this is not parameterized as a conic but rather as a line segment, the parameters for the limits of the conic are defined simply as the (s, t) values of the border point. From the coefficients of the curve, it is possible to obtain x₀ and y₀.

$${y}_{0} = \frac{2 {C}_{1} {C}_{5} - {C}_{3} {C}_{4}}{4 {C}_{1} {C}_{2} - {C}_{3}^{2}} , {x}_{0} = \{ \begin{matrix}\frac{{C}_{4} - {C}_{3} {y}_{0}}{2 {C}_{1}} , & if {C}_{1} \neq 0 \\ \frac{{C}_{5} - 2 {C}_{2} {y}_{0}}{{C}_{3}} , & otherwise\end{matrix}$$

The calculation for the (s, t) parameter pair for the line segments will be achieved by expressing s in terms of t or vice-versa. There will be two equations, one for each segment. A straightforward approach is to parameterize s in terms of t by the pairs of equations

$$s = \frac{( - {C}_{3} + {α}_{s} ) ( t + {y}_{0} )}{2 {C}_{1}} - {x}_{0}$$

$$and$$

$$s = \frac{( - {C}_{3} - {α}_{s} ) ( t + {y}_{0} )}{2 {C}_{1}} - {x}_{0} .$$

However, there is a possibility of C₁=0, breaking the equation. In that case,

$${y}_{0} = \frac{2 {C}_{1} {C}_{5} - {C}_{3} {C}_{4}}{4 {C}_{1} {C}_{2} - {C}_{3}^{2}}$$

simplifies to

$${y}_{0} = \frac{{C}_{4}}{{C}_{3}}$$

and t is placed in terms of s instead resulting in the following pair of equations:

$$t = \frac{- {C}_{3} ( s + {x}_{0} )}{{C}_{2} - {y}_{0}} and t = - {y}_{0}$$

for all s within the interval.

One should consider the possibility of C₂=0 along with C₁. In this case, one segment will be given in terms of

$$s = \frac{- {C}_{5}}{{C}_{3}}$$

for all valid t and the other given in terms of

$$t = \frac{- {C}_{4}}{{C}_{3}}$$

for all valid s.

Parallel Lines Slicing

If the conic curve in the parametric space degenerates as a pair of parallel lines, then each segment is computed independently. Let δ=C₄²−4C₁C₆. If C₁≠0 and δ≥0, then the values of s can be parameterized in terms of t for both segments:

Let

$${s}_{1} = \frac{- {C}_{3} {t}_{1} - {C}_{4} + \sqrt{δ}}{2 {C}_{1}}$$

for all valid t₁ on the first segment and let

$${s}_{2} = \frac{- {C}_{3} {t}_{2} - {C}_{4} - \sqrt{δ}}{2 {C}_{1}}$$

for all valid t₂ on the second segment. If, however, C₁=0 but C₂≠0, then instead make δ=C₅²−4C₂C₆ and compute

$${t}_{1} = \frac{- {C}_{5} + δ}{2 {C}_{2}}$$

constant for all valid s₁ in the first segment and

$${t}_{2} = \frac{- {C}_{5} - δ}{2 {C}_{2}}$$

also constant for every valid s₂ on the second segment. If none of the conditions are met the parameter pair will either be

$$( \frac{- {C}_{6}}{{C}_{4}} , t )$$

for all valid t if

$${C}_{4} > {C}_{5} or ( s , \frac{- {C}_{6}}{{C}_{5}} )$$

otherwise.

Single Line Slicing

For the case where the conic curve has degenerated into a single line, the parameters for the slice will be given by

$$s = \frac{- {C}_{5} t - {C}_{6}}{{C}_{4}}$$

for all valid t if C₄≠0. If C₄=0 however, then the slicing will be put in terms of

$$t = \frac{- {C}_{6}}{{C}_{5}} ,$$

with s arbitrary within the interval.

Coincident Lines Slicing

In some instances, the conic curve in the parametric space will degenerate into a pair of coincident lines. Normally this case would be like the single line, however since these are limited line segments are treated specifically. Since there are several possible parameterizations for the values of (s, t) depending on the values of C₁, C₂, . . . , C₆, it is useful to display them as a table:

| | | | |
|---|---|---|---|
| C₃ ≠ 0 | ${C}_{6} = \frac{{C}_{4} {C}_{5}}{2 {C}_{3}}$ | C₃ > 0 | $\begin{matrix}\sqrt{{C}_{1}} s + \sqrt{{C}_{2}} t = - \sqrt{{C}_{6}} \\ or \\ \sqrt{{C}_{1}} s + \sqrt{{C}_{2}} t = \sqrt{{C}_{6}}\end{matrix}$ |
| | | C₃ < 0 | $\begin{matrix}\sqrt{{C}_{1}} s - \sqrt{{C}_{2}} t = \sqrt{{C}_{6}} \\ or \\ \sqrt{{C}_{1}} s - \sqrt{{C}_{2}} t = - \sqrt{{C}_{6}}\end{matrix}$ |
| C₃ = 0 | C₁ = 0, C₂ ≠ 0 | ${C}_{6} = \frac{{C}_{5}^{2}}{4 {C}_{2}}$ | $t = \frac{- {C}_{5}}{2 {C}_{2}} for all s$ |
| | C₁ ≠ 0, C₂ = 0 | ${C}_{6} = \frac{{C}_{4}^{2}}{2 {C}_{1}}$ | $s = \frac{- {C}_{4}}{2 {C}_{1}} for all t$ |

Point Slicing

Computing the slice for the conic which degenerated into a point is trivially accomplished by letting

$$s = \frac{{C}_{3} {C}_{4} - 2 {C}_{1} {C}_{5}}{4 {C}_{1} {C}_{2} - {C}_{3}^{2}} , t = \{ \begin{matrix}\frac{{C}_{3} {y}_{0} - {C}_{4}}{2 {C}_{1}} , & if {C}_{1} \neq 0 \\ \frac{2 {C}_{2} {y}_{0} - {C}_{5}}{{C}_{3}} , & otherwise\end{matrix} .$$

Although the present disclosure has been described with reference to example implementations, workers skilled in the art will recognize that changes may be made in form and detail without departing from disclosure. For example, although different example implementations may have been described as including features providing various benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. A non-transitory computer-readable medium containing instructions to direct a processor to:
obtain a Steiner patch that is part of a tessellation approximation of a three-dimensional (3D) object to be printed by a 3D printer;
determine a slicing curve, the slicing curve being an intersection of a slicing plane and the Steiner patch in Euclidian space;
determine a parametric curve of the slicing curve, the parametric curve existing in a parametric space;
determine a classification of the parametric curve;
determine border points of the parametric curve;
sample points along the parametric curve between the border points of the parametric curve based on the classification; and
generate 3D printing points in Euclidean space for the object based upon the sampled points, the 3D printing points for use in 3D printing of the 3D object.

2. The medium of claim 1, wherein the sampling of points along the parametric curve comprises sampling a first point and sampling a second point spaced from the first point by a parametric spacing along the parametric curve and between the border points of the parametric curve and wherein the instructions are to further direct the processor to:
determine a Euclidean spacing of the first point and the second point in Euclidean space;
compare the Euclidean spacing to a predefined spacing threshold; and
in response to the Euclidean spacing failing to satisfy the predefined threshold, sample a third point along the parametric curve between the first point and the second point in parametric space, wherein the 3D printing points are generated based upon the third point.

3. The medium of claim 1, wherein the sampling of points along the parametric curve comprises sampling a first point and sampling a second point spaced from the first point by a parametric spacing along the parametric curve and between the border points in parametric space, the instructions are to further direct the processor to:
determine a Euclidean spacing of the first point and the second point in Euclidean space;
compare the Euclidean spacing to a predefined spacing threshold; and
in response to the Euclidean spacing failing to satisfy the predefined threshold, sample a third point along the parametric curve between the first point and the second point;
determine a Euclidean spacing of the first point and the third point in Euclidean space;
compare the Euclidean spacing of the first point and the third point to the predefined spacing threshold; and
in response to the Euclidean spacing of the third point and the first point not satisfying the predefined threshold,
sample a fourth point along the parametric curve between the first point and the third point;
determine a Euclidean spacing of the first point and the fourth point in Euclidean space;
compare the Euclidean spacing of the first point and the fourth point to the predefined spacing threshold; and
in response to the Euclidean spacing of the first point and the fourth point satisfying the predefined threshold, generate the 3D printing points based on the fourth point.

4. The medium of claim 1, wherein the instructions are to further direct the processor to:
in response to the parametric curve being classified as parabola,
compare vertex coordinates of the parametric curve to a distance threshold; and
in response to any of the vertex coordinates failing to satisfy the distance threshold, assign the parametric curve a single line classification, wherein the sampling of points along the parametric curve between the border points of the parametric curve is based upon the single line classification.

5. The medium of claim 1, wherein the instructions are to further direct the processor to replace a non-degenerate classification of the parametric curve with a degenerate classification of the parametric curve, wherein sampling of points along the parametric curve between the border points of the parametric curve is based upon the degenerate classification.

6. The medium of claim 1, wherein the instructions are to further direct the processor to:
determine a parametric distance of a point of the parametric curve from an origin of the parametric space;
assign the parametric curve a single line classification in response to the parametric distance of the point of the parametric curve satisfying a predefined distance threshold, wherein the sampling of points along the parametric curve between the border points of the parametric curve is based upon the single line classification.

7. The medium of claim 6, wherein the point of the parametric curve used for determining the parametric distance is a center of the parametric curve.

8. The medium of claim 6, wherein the parametric curve has a parabola classification and wherein the point of the parametric curve used for determining the parametric distance is a vertex of the parametric curve.

9. A computer implemented method for generating three-dimensional (3D) printing points for printing a 3D object, the method comprising:
obtaining a Steiner patch that is part of a tessellation approximation of the 3D object;
determine a slicing curve, the slicing curve being an intersection of a slicing plane and the Steiner patch in Euclidean space;
determine a parametric curve of the slicing curve, the parametric curve existing in a parametric space;
determining a classification of the parametric curve;
sampling a first point and sampling a second point spaced from the first point by a parametric spacing along the parametric curve based upon the classification;
determining a Euclidean spacing of the first point and the second point;
comparing the Euclidean spacing to a predefined spacing threshold; and
in response to the Euclidean spacing failing to satisfy the predefined threshold, sampling a third point along the parametric curve between the first point and the second point in parametric space;
generate 3D printing points in Euclidean space for the object based upon the first point, second point and third point sampled along the parametric curve, the 3D printing points for use in 3D printing of the 3D object.

10. The method of claim 9 further comprising:
determine a Euclidean spacing of the first point and the third point;
compare the Euclidean spacing of the first point and the third point to the predefined spacing threshold; and
in response to the Euclidean spacing of the third point and the first point not satisfying the predefined threshold,
sample a fourth point along the parametric curve between the first point and the third point;
determine a Euclidean spacing of the first point and the fourth point;
compare the Euclidean spacing of the first point and the fourth point to the predefined spacing threshold; and
in response to the Euclidean spacing of the first point and the fourth point not satisfying the predefined threshold, sample a fifth point along the parametric curve between the first point and the fourth point, wherein the generation of the 3D printing points in Euclidean space for the object is based upon the first point, second point, the third point, the fourth point and the fifth point sampled along the parametric curve.

11. The method of claim 11, wherein the parametric curve is assigned a single line classification, wherein the sampling of the first point and the second point along the parametric curve is based upon the single line classification.

12. The method of claim 11, wherein the parametric curve has a non-degenerate classification, the method comprising sampling the first point and the second point along the parametric curve based upon a degenerate classification.

13. A method for generating three-dimensional (3D) printing points for printing a 3D object, the method comprising:
obtaining a Steiner patch that is part of a tessellation approximation of a three-dimensional object to be printed by a 3D printer;
determine a slicing curve, the slicing curve being an intersection of a slicing plane and the Steiner patch in Euclidian space;
determine a parametric curve of the slicing curve, the parametric curve having a non-degenerate conic classification;
reclassifying the parametric curve as a degenerate conic classification; and
sampling points along the parametric curve based upon the degenerate conic classification; and
generate 3D printing points in Euclidean space for the 3D object based upon the points sampled along the parametric curve.

14. The method of claim 13 wherein the reclassifying of the parametric curve as a degenerate conic classification comprises reclassifying the parametric curve as a single line degenerate conic classification in response to the parametric distance of a point of the parametric curve satisfying a predefined distance threshold.

15. The method of claim 14, wherein the sampling of points along parametric curve comprises iteratively adding sample points along the parametric curve until a spacing between each consecutive pair of the sample points in Euclidean space satisfies a predefined threshold.
